(19) United States
(12) Patent Application Publication
(10) Pub. No.: US 2013/0115420 A1
(43) Pub. Date: May 9, 2013

(54) NANO COMPOSITE WITH SUPERHYDROPHOBIC SURFACE AND METHOD OF MANUFACTURING THE SAME

(71) Applicant: Samsung Electronics Co., Ltd., Suwon-si (KR)

(72) Inventors: Sung-hoon PARK, Yongin-si (KR); Eun-hyoung CHO, Yongin-si (KR); Jin-seung SOHN, Yongin-si (KR); Dong-earn KIM, Yongin-si (KR); Dong-ouk KIM, Yongin-si (KR); Ha-jin KIM, Yongin-si (KR); Min-jong BAE, Yongin-si (KR); Yoon-chul SON, Yongin-si (KR); Sang-eui LEE, Yongin-si (KR); Kun-mo CHU, Yongin-si (KR)

(73) Assignee: SAMSUNG ELECTRONICS CO., LTD., Suwon-si (KR)

(21) Appl. No.: 13/685,365

(22) Filed: Nov. 26, 2012

(30) Foreign Application Priority Data
Apr. 17, 2011 (KR) 10-2012-0039966
Nov. 25, 2011 (KR) 10-2011-0124388

(51) Int. Cl. B32B 3/30

(52) U.S. Cl. CPC B32B 3/30; B82Y 30/00
USPC 428/141; 264/293; 264/496; 977/762; 977/734; 977/742; 977/773

(57) ABSTRACT

A nano composite with superhydrophobic surfaces including a bulk portion and a surface portion having a superhydrophobic pattern, wherein the bulk portion and the surface portion include the same material, and methods of manufacturing of the nano composite.

### CROSS-REFERENCE TO RELATED APPLICATIONS

This application claims priority to and the benefit of Korean Patent Application No. 10-2011-0124388, filed on Nov. 25, 2011, and Korean Patent Application No. 10-2012-0039966, filed on Apr. 17, 2012, and all the benefits accruing therefrom under U.S.C. §119, the content of which are incorporated herein in their entirety by reference.

### BACKGROUND

1. Field

The present disclosure relates to superhydrophobic nano structures, and more particularly, to nano composites with superhydrophobic surfaces and methods of manufacturing the same.

2. Description of the Related Art

A nano composite, such as a carbon nanotube composite, has excellent electrical, mechanical, and electromagnetic properties. For example, if a polymer nano composite is formed by combining a polymer, which is an insulator having weak mechanical strength, with nano materials, such as carbon nanotubes, carbon fibers, graphene, etc., properties of the polymer may be retained while electric conductivity and mechanical strength may be improved. Such nano composites are useful in various fields, such as electronic component packaging, lightweight materials, sensors, electromagnetic wave shielding and absorbing materials, etc.

However, if a nano composite is exposed to an outside environment, the nano composite may be damaged or deteriorated due to environmental causes, such as rain and wind. To solve the problem, surfaces of a nano composite may have superhydrophobicity.

Superhydrophobicity refers to a physical property by which a surface of an object may hardly be wetted, i.e., resists wetting. In nature, surfaces of leaves of plants, wings of insects, and wings of birds have superhydrophobic properties by where any external pollutants are prevented from adhering or removed with water, which sheds off the surface. In industry, a superhydrophobic surface is formed by creating a microscopically rough surface containing sharp edges and air pockets in a material of poor wettability, i.e., a material that is not easily wettable and sheds water well. On a superhydrophobic surface, a drop of water will form a nearly spherical bead that will roll when the surface is slightly tilted.

Since superhydrophobic surfaces shed water easily, an object with superhydrophobic surfaces may have properties such as water resistance and antifouling. Therefore, techniques for forming superhydrophobic surfaces may be useful in various industries. Furthermore, by adding superhydrophobicity to surfaces of a nano composite, friction resistance of the surfaces of the nano composite may be reduced, and thus fuel use reduction in automobiles, ships, and aircrafts may be achieved. Thus, development of the new techniques for forming superhydrophobic surfaces of nano composite would be beneficial and may be applicable in various industries.

### SUMMARY

Provided are nano composites with superhydrophobic surfaces.

Provided are methods of manufacturing nano composites with superhydrophobic surfaces.

Additional aspects will be set forth in part in the description which follows and, in part, will be apparent from the description, or may be learned by practice of the presented embodiments.

According to an embodiment, a nano composite with superhydrophobic surfaces including a bulk portion and a surface portion having a superhydrophobic pattern including a plurality of protrusions, and wherein the bulk portion and the surface portion include the same material, is provided.

In another embodiment, a width of the protrusions, a height of the protrusions, and an interval between adjacent protrusions are from about 10 nanometers (“nm”) to about 500 micrometers (“μm”).

In another embodiment, the surface portion exhibits a contact angle equal to or greater than 130° and less than 180°.

In another embodiment, the protrusions are of cylindrical shape, polygonal pillar-like shape, or conical shape. In yet another embodiment, the plurality of protrusions forms a moth-eye pattern.

In another embodiment, the nano composite further includes a polymer base and a nano filler.

In another embodiment, the polymer base includes a thermoplastic polymer.

In another embodiment, the polymer base includes a curable polymer.

In another embodiment, the nano filler includes carbon black, carbon nanotubes, carbon fibers, nano wires, graphene, or nano particles.

In another embodiment, the nano filler includes carbon nanotubes.

In another embodiment, a content of the nano filler with respect to the overall weight of the nano composite is from about 0.01 weight percent (“wt %”) to about 50 wt % with respect to the overall weight of the nano composite.

In another embodiment, a content of the nano filler with respect to the overall weight of the nano composite is from about 1 wt % to about 50 wt % with respect to the overall weight of the nano composite.

In another embodiment, the nano composite has a shielding efficiency of 10 decibel (“dB”) or higher with respect to electromagnetic waves with 10 gigahertz (“GHz”) frequency.

In another embodiment, the nano composite has a contact angle equal to or greater than 130°.

In another embodiment, a surface area of a region in which the superhydrophobic pattern is formed is 2 or more times larger than that of a flat surface of the equivalent region.

According to another embodiment, a method of manufacturing a nano composite with superhydrophobic surfaces, wherein the method includes providing a nano composite material containing a polymer base and a nano filler; and contacting a surface of a mold having a superhydrophobic pattern to a surface of the nano composite material, is provided.

According to another embodiment, the polymer base includes a curable polymer, and the contacting of the mold to the surface of the nano composite material further includes curing the nano composite material by providing heat or light thereto.

According to another embodiment, the polymer base includes a thermoplastic polymer, and the contacting of the mold to the surface of the nano composite material further includes applying heat to raise the temperature of the thermoplastic polymer to near the melting point of the thermoplastic polymer and applying pressure to the nano composite material.

### BRIEF DESCRIPTION OF THE DRAWINGS

These and/or other aspects will become apparent and more readily appreciated from the following description of embodiments, taken in conjunction with the accompanying drawings of which:

FIGS. 1A through 1D are sectional views of a nano composite with superhydrophobic surfaces;

FIGS. 2A through 2C are diagrams showing a method of manufacturing a nano composite with superhydrophobic surfaces according to an embodiment;

FIGS. 3A through 3C are diagrams showing a method of manufacturing a nano composite with superhydrophobic surfaces according to another embodiment;

FIG. 4A is a diagram showing a contact angle when a liquid drop is located on a surface of a solid between vapor and the solid;

FIG. 4B is a diagram showing a shape of the hexahedral protrusions formed on the surface of the solid;

FIG. 5A is a diagram showing an image of a plastic nano composite with superhydrophobic surfaces according to an embodiment;

FIGS. 5B through 5D are diagrams showing an image of a curable nano composite with superhydrophobic surfaces according to embodiments;

FIG. 6A is a diagram showing a mechanism of shielding against electromagnetic waves;

FIG. 6B is a graph showing an electromagnetic wave shielding efficiency of a nano composite with superhydrophobic surfaces (decibel, dB) versus frequency (hertz, Hz) according to an embodiment;

]FIG. 6C is a graph showing an electromagnetic wave shielding efficiency via absorption and electromagnetic wave shielding efficiency via reflection of a nano composite with superhydrophobic surfaces (decibel, dB) versus frequency (hertz, Hz) according to an embodiment; and

FIG. 6D is a graph showing electromagnetic wave shielding efficiency via absorption and electromagnetic wave shielding efficiency via reflection of a nano composite with no superhydrophobic surface (decibel, dB) versus frequency (hertz, Hz).

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. These embodiments are provided so that this disclosure will be thorough and complete, and will fully convey the scope of the claims to those skilled in the art.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer, or section discussed below could be termed a second element, component, region, layer, or section without departing from the teachings of embodiments.

The terminology used herein is for the purpose of describing particular embodiments only and is not intended to be limiting. As used herein, the singular forms “a,” “an” and “the” are intended to include the plural forms as well, unless the context clearly indicates otherwise. The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

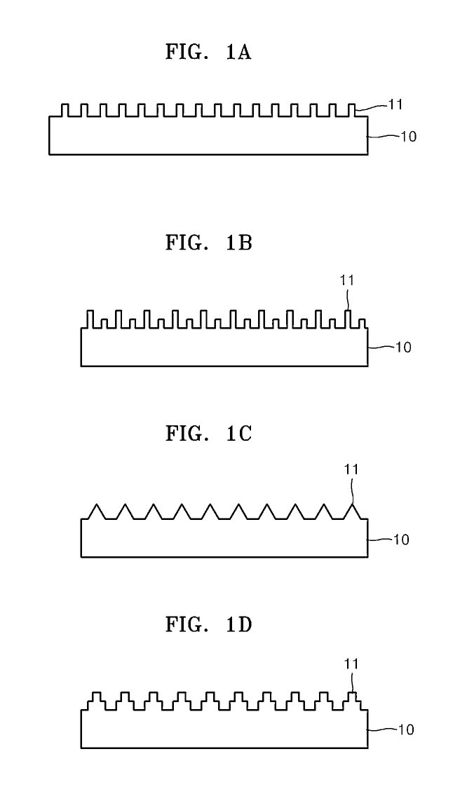

FIGS. 1A through 1D are sectional views of a nano composite with superhydrophobic surfaces. Referring to FIG. 1A, the nano composite with superhydrophobic surfaces includes a bulk portion 10 and a surface portion 11 formed directly on the bulk portion 10, wherein the surface portion 11 includes a superhydrophobic pattern. The bulk portion 10 and the surface portion 11 may be fabricated from the same material.

The superhydrophobic pattern is formed by a plurality of protrusions. The superhydrophobic pattern may include a plurality of protrusions of various vertical and horizontal cross-sectional shapes, e.g., circular shape, triangular shape, quasi-triangular shape, triangular shape with semi-circles, triangular shape with one or more rounded corners, square shape, rectangular shape, rectangular shape with semi-circles, polygonal shape, or any of various common regular and irregular shapes. The superhydrophobic pattern may also include a plurality of protrusions of any of various three-dimensional shapes, e.g., spherical shape, elliptical shape, cubical shape, tetrahedral shape, pyramidal shape, octahedral shape, cylindrical shape, polygonal pillar-like shape, conical shape, columnar shape, tubular shape, helical shape, funnel shape, dendritic shape, or any of various common regular and irregular shapes. The superhydrophobic pattern may further include a plurality of protrusions of “mushroom” shape, wherein the shape of protrusions is characterized by a thin root with a diameter of less than about 10 nanometers (“nm”) bonding to the bulk portion and a large cap with suitable geometry and size. In another embodiment, the plurality of protrusions may form a moth-eye pattern, characterized by a hexagonal array of conical protrusions. Each of the protrusions may have the same or different shape, height, and width. The intervals between the protrusions may also be the same or different. A width of the protrusion, a height of the protrusion, and an interval between the adjacent protrusions of the superhydrophobic pattern may be from about 10 nanometers (“nm”) to about 500 micrometers (“μm”).

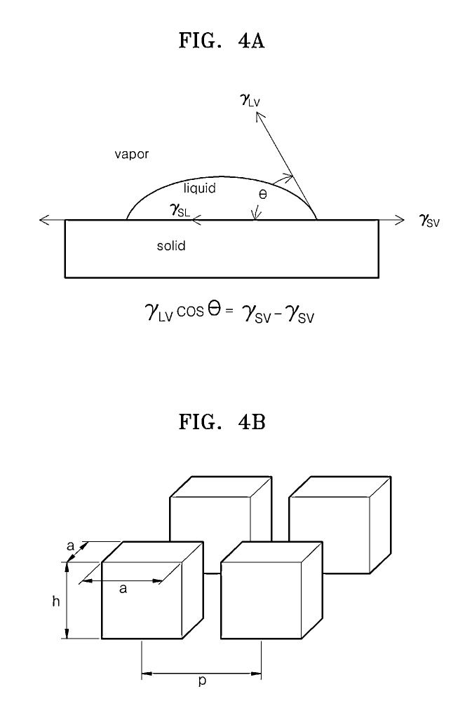

The hydrophobicity of the nano composite surface is characterized by the contact angle θ, which is an angle measured through the liquid at the point where a liquid/vapor interface meets a solid surface of the nano composite (FIG. 4A). The contact angle θ reflects the relative strength of the liquid, vapor and nano composite molecular interaction, and is a function of molecular composition of liquid, vapor and nano composite, temperature and pressure. In an embodiment, the term “superhydrophobic” in reference to the superhydrophobic surfaces of the nano composite and to the superhydrophobic pattern including a plurality of protrusions refers to the ability of the surface portion 11 of the nano composite to exhibit the contact angle θ of equal to or greater than 90° and less than 180°. Specifically, the surface portion 11 of the nano composite with superhydrophobic surfaces may exhibit a contact angle θ equal to or greater than 130° and less than 180°. Here, due to the shape of the superhydrophobic pattern of the nano composite 100, a surface area of a region in which the superhydrophobic pattern is located may be at least twice as large as that of an equivalent region having a flat surface.

Although FIG. 1A shows a superhydrophobic pattern having protrusions of even cross-sectional shape, the superhydrophobic pattern formed on the surface portion 11 of the nano composite may have a combination of any of the foregoing shapes. As shown in FIG. 1B, the superhydrophobic pattern on the surface portion 11 may have a plurality of protrusions of different heights, and optionally different cross-sectional shapes (not shown). These cross-sectional shapes are not limited to rectangular shapes and may have triangular shapes, as shown in FIG. 1C, or any of various other shapes as indicated above. Furthermore, as shown in FIG. 1D, the superhydrophobic pattern of the surface portion 11 may further include additional protrusions formed on the protrusions.

If a superhydrophobic pattern is simply attached to a surface of a substrate formed of a substrate material, e.g., silicon, glass, or a polymer, via a coating process, the superhydrophobic pattern may be peeled off, and the durability of the superhydrophobic pattern may be deteriorated when exposed to an outside environment. However, in a nano composite as described herein a superhydrophobic pattern is directly formed on a surface of a bulk portion of the nano composite, and thus resistance against wear-off or rubbing may be improved. The superhydrophobic pattern may be present on all or a portion of a surface of the bulk portion.

A nano composite according to an embodiment may be formed of a polymer base and a nano filler. Here, the polymer base may include either a thermoplastic polymer or a curable polymer.

The nano filler may be carbon black, carbon nanotubes, carbon fibers, nano wires, graphene, nano particles, or any other nano material. In an embodiment, the nano filler is a conductive material, in particular carbon black, carbon nanotubes, carbon fibers, nano wires, bucky balls (also known as fullerene C60, and/or Buckminster fullerene), graphite nanoparticles, graphene sheets, metal nanoparticles, or inorganic nanotubes which may contain metallic components including, but not limited to gold, cobalt, cadmium, copper, iron, lead, zinc, as well as silicate based nanoparticles such as silica, polyhedral oligomeric silsesquioxanes, layered silicates, and derivatives thereof. A combination of different nano fillers can be used. Furthermore, the nano composite may further include organic or inorganic materials other than the polymer base and the nano filler, for example one or more additives such as a colorant, flame retardant, ultraviolet light stabilizer, heat stabilizer, antioxidant, diffusing agent, mold release agent, or other filler. The type and amount of such additive(s) will depend on the particular application. A content of the nano filler in the nano composite may be from about 0.01 weight percent (“wt %”) to about 80 wt % with respect to the overall weight of the nano composite. Specifically, the content of the nano filler may be from about 0.1 wt % to about 50 wt %, or about 0.1 to about 40 wt %, with respect to the overall weight of the nano composite. More specifically, the content of the nano filler may be from about 1 wt % to about 50 wt % with respect to the overall weight of the nano composite. As the nano filler is added to a polymer base, the nano composite may have improved tensile strength, elastic modulus, and toughness compared to the polymer base alone.

In a nano composite with superhydrophobic surfaces according to an embodiment, a surface portion having a superhydrophobic pattern may be directly formed on a nano composite material constituting a bulk portion via a molding process or a press stamping process.

Hereinafter, a method of manufacturing a nano composite with superhydrophobic surfaces will be described with reference to the attached drawings. Basically, a nano composite with superhydrophobic surfaces according to an embodiment may be manufactured by preparing a nano composite material including a polymer base and a nano filler and contacting a surface of a mold having a predetermined pattern to the nano composite material.

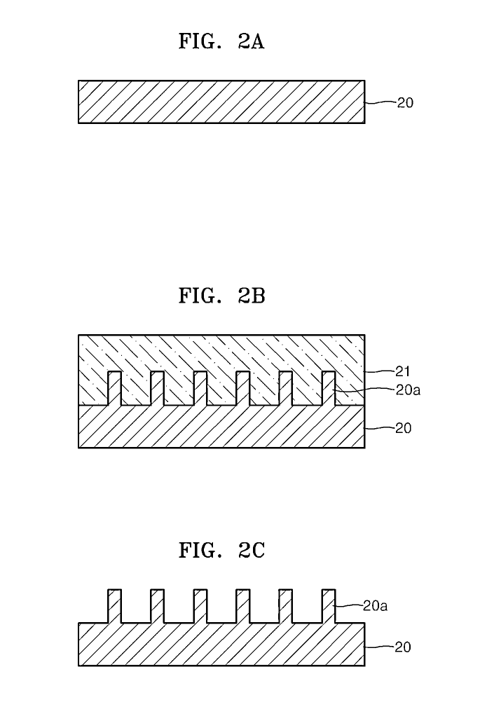

FIGS. 2A through 2C are diagrams showing a method of manufacturing a nano composite with superhydrophobic surfaces according to an embodiment wherein the nano composite is formed of a thermoplastic material.

Referring to FIG. 2A, a thermoplastic nano composite 20 is prepared. The thermoplastic nano composite 20 may be formed by synthesizing a material including a nano filler and a thermoplastic polymer, optionally together with any other additives suitable for the particular application. The thermoplastic polymer may be reactive ethylene terpolymer (“RET”, a reactive terpolymer of ethylene, butyl acrylate, and glycidyl methacrylate), acrylonitrile butadiene-styrene copolymer (“ABS”), polymethyl methacrylate (“PMMA”), methyl pentene polymer (poly(4-methyl-1-pentene), “MPP”), polyimide (“PI”), polyetherimide (“PEI”), polyvinylidene fluoride (“PVDF”), polyvinylidene chloride (“PVDC”), polycarbonate (“PC”), polystyrene (“PS”), nylon (polyamide, “PA”), polyethylene terephthalate (“PETP”), polyphenylene oxide (“PPO”), polyvinyl chloride (“PVC”), celluloid polymer, cellulose acetate, cyclic olefin copolymer (“COC”), ethylene vinyl acetate (“EVA”), ethylene vinyl alcohol, (“EVOH”), fluoropolymers (such as polytetrafluoroethylene “PTFE”, fluorinated ethylene propylene “FEP”, perfluoroalkoxy “PFA”, chlorotrifluoroethylene “CTFE”, ethylene chlorotrifluoroethylene “ECTFE”, and ethylene tetrafluoroethylene “ETFE”), liquid crystal polymer (“LCP”), polyoxymethylene (“POM”), polyacrylates, polyacrylonitrile (“PAN”), polyamide imide (“PAI”), polyaryletherketone (“PAEK”), polybutadiene (“PBD”), polybutylene (“PB”), polybutylene terephthalate (“PBT”), polycyclohexylene dimethylene terephthalate (“PCT”), polyhydroxylalkanoates (“PHAs”), polyketone (“PK”), polyester, polyethylene (“PE”), polyetheretherketone (“PEEK”), polyetherketoneketone (“PEKK”), polyethersulfone (“PES”), chlorinated polyethylene (“CPE”), polylactic acid (“PLA”), polyphenylene sulfide (“PPS”), polyphthalamide (“PPA”), polypropylene (“PP”), polysulfone (“PSU”), polytrimethylene terephthalate (“PTT”), polyurethane (“PU”), polyvinyl acetate (“PVA”), polyvinylidene chloride (“PVDC”), styrene acrylonitrile (“SAN”), or any other commonly known thermoplastic polymer. The nano filler may be carbon black, carbon nanotubes, carbon fibers, nano wires, graphene, nano particles, or any other nano material as described above. The nanotubes may be single walled nanotubes (“SWNTs”) or multi walled nanotubes (“MWNTs”).

Specifically, the nano composite material may be RET, whereas the nano filler may be single walled nanotubes. Furthermore, any of various other combinations may be used. A content of the nanotubes with respect to the overall mass of the nano composite may be selectively adjusted, e.g., from about 0.01 wt % to about 80 wt %, specifically, from about 0.01 wt % to about 50 wt %, more specifically, from about 0.1 wt % to about 50 wt %, even more specifically, from about 1 wt % to about 50 wt %. The method of mixing is not particularly critical and may be carried out by a variety of means, for example dispersion, blending, stirring, sonication, sparging, milling, shaking, centrifugal circulating pump mixing, blade mixing, impact mixing, jet mixing, homogenization, co-spraying, high sheer mixing, single pass and multi-pass mixing, and the like. During the synthesis of the thermoplastic nano composite, a paste mixer may be used for effective dispersion of the nano filler. The paste mixer may be revolved and rotated after the polymer and the nano filler of desired amounts are put into a container. After the polymer and the nano filler are mixed for an effective time, for example 10 to 60 minutes by using the paste mixer, the nano filler in the polymer may be effectively dispersed by using 3-roll milling equipment. Accordingly, a nano composite with a uniform nano filler dispersion may be formed. Since the nano composite includes nano tubes with high conductivity and a high aspect ratio (from several hundreds to several tens of thousands), the nano composite may exhibit high electric conductivity, high mechanical performance, and electromagnetic shieldability. This method of manufacturing a nano composite may be used in a process of manufacturing a nano composite regardless of a type of a polymer and a type of a nano filler.

Referring back to FIG. 2A, the prepared thermoplastic nano composite 20 may be heated to the point at or near which the nano composite 20 is melted. The heating process may be performed by placing the nano composite 20 on a hot plate and applying heat thereto. For example, if the nano composite 20 is a composite material, such as SWNT/RET, the nano composite 20 may be heated to a temperature around 75° C., which is the melting point of SWNT/RET. When sufficient heat is applied to the thermoplastic nano composite 20, the thermoplastic nano composite 20 may be softened or melted by the applied heat.

Referring to FIG. 2B, pressure may be applied to a surface of the thermoplastic nano composite 20 of FIG. 2A using a surface of a mold, for example a nickel (Ni) press stamp 21. Here, a pattern opposite to a superhydrophobic pattern 20a may be formed on a surface of the Ni press stamp 21. When sufficient pressure is applied to the surface of the thermoplastic nano composite 20, the superhydrophobic pattern 20a may be formed on the surface of the thermoplastic nano composite 20 according to the shape of the pattern on the surface of the Ni press stamp 21. A shape, height, and diameter of the protrusions of the superhydrophobic pattern 20a may be controlled by controlling the corresponding pattern on the surface of the Ni press stamp 21.

Referring to FIG. 2C, the plastic nano composite 20 on which the superhydrophobic pattern 20a is formed may be separated from the mold, e.g., Ni press stamp 21. Here, while the thermoplastic nano composite 20 is being separated from the Ni press stamp 21, the superhydrophobic pattern 20a may be deformed. To reduce deformation of the superhydrophobic pattern 20a, the thermoplastic nano composite 20 and the Ni press stamp 21 may be sufficiently cooled before being separated.

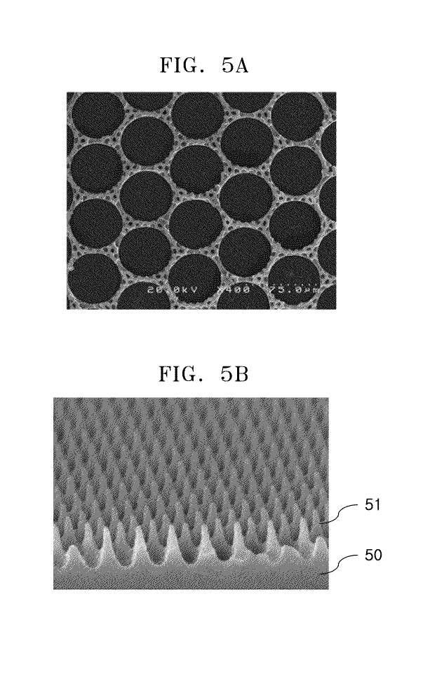

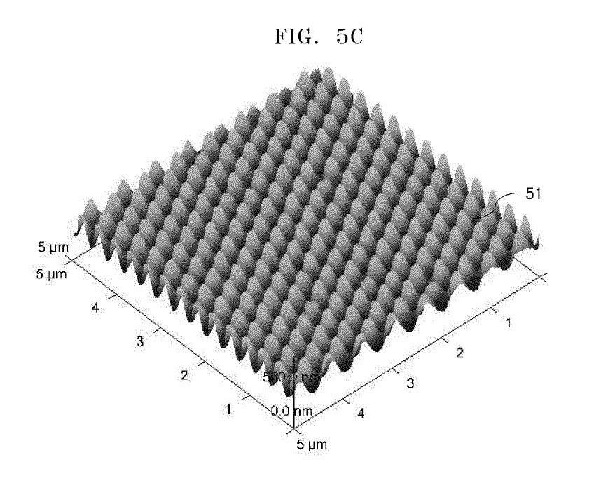

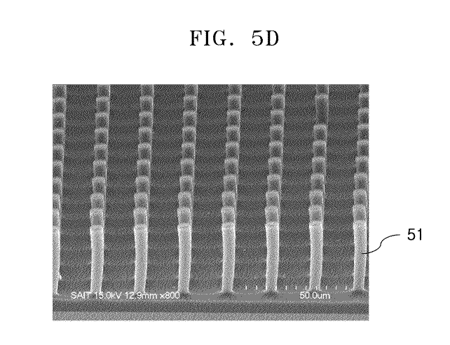

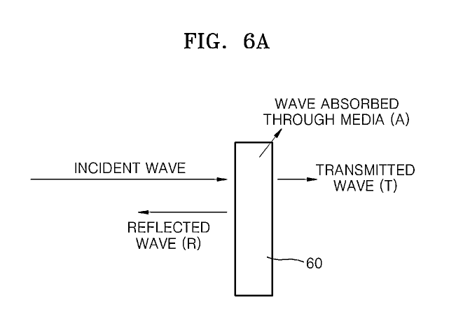

An image of a nano composite with superhydrophobic surfaces that is manufactured by using a thermoplastic nano composite material as described above is shown in FIG. 5D. A shape of a superhydrophobic surface may be controlled according to a shape of a surface of a Ni press stamp, and thus a nano composite with superhydrophobic surfaces on which various shapes are arranged may be acquired.

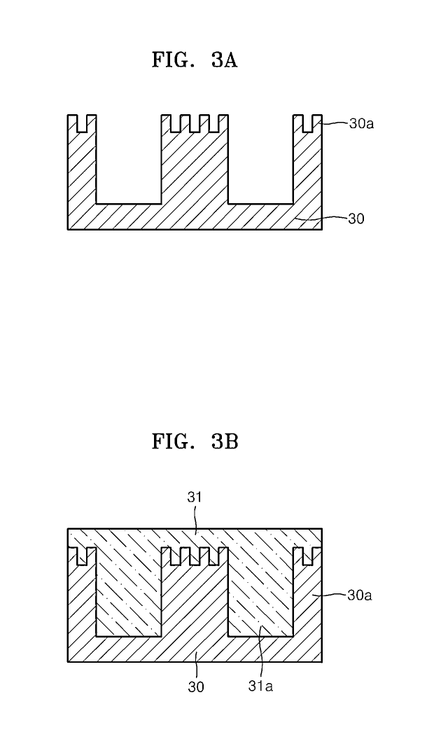

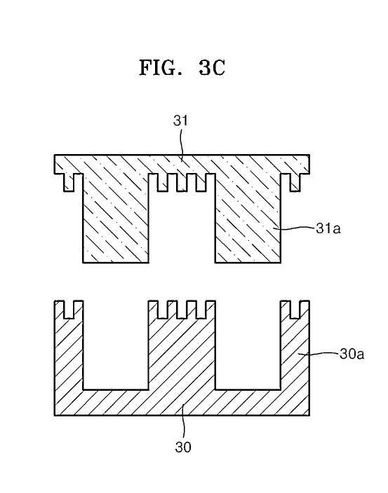

FIGS. 3A through 3C are diagrams showing a method of manufacturing a nano composite with superhydrophobic surfaces according to another embodiment wherein the nano composite is formed of a curable material.

Referring to FIG. 3B, a curable nano composite 31 is provided on a mold 30. The curable nano composite 31 may be formed by synthesizing a curable polymer from a polymer base material containing a nano filler, optionally together with any other additives suitable for the particular application. The curable polymer may not only be a thermally-curable polymer, but may also be catalyst-curable polymer, an ultraviolet (“UV”) curable polymer, etc. The curable polymer may be a reactive polydimethylsiloxane (“PDMS”) formulation, for example a two-part formulation containing a PDMS with terminal vinyl reactive groups and a PDMS with terminal methylhydrogen groups, a perfluoropolyether such as Fluorolink (trade name “FLK MD700”), polyurethane (“FUR”), reactive polyester, unsaturated polyester (“UP”), polyacrylate, polymethacrylate, phenolics (“PF”), alkyd molding compound (“ALK”), allylics (allyl resin) (“DAP”), epoxy resin (“EP”), vulcanized rubber, bakelite, duroplast, urea-formaldehyde foam, melamine resin, or other commonly known polymers. The nano filler may be carbon black, carbon nanotubes, carbon fibers, nano wires, graphene, nano particles, or other nano material. The nanotubes may be single walled or multi walled nanotubes. The curable nano composite 31 may be formed of any of various combinations of the materials stated above.

A nano composite may be manufactured by using various methods. For example, the curable polymer may be a reactive PDMS formulation for example a two-part formulation containing a PDMS with terminal vinyl reactive groups and a PDMS with terminal methylhydrogen groups, or perfluoropolyether such as FLK MD700, whereas the nano filler may be MWNTs. A content of the nanotubes with respect to the overall mass of the nano composite may be selectively adjusted, e.g., from about 0.01 wt % to about 80 wt %, specifically, from about 0.01 wt % to about 50 wt %, more specifically, from about 0.1 wt % to about 50 wt %, even more specifically, from about 1 wt % to about 50 wt %. The method of mixing is not particularly critical and may be carried out by a variety of means, for example dispersion, blending, stirring, sonication, sparging, milling, shaking, centrifugal circulating pump mixing, blade mixing, impact mixing, jet mixing, homogenization, co-spraying, high sheer mixing, single pass and multi-pass mixing, and the like. During synthesis of the curable nano composite, a paste mixer may be used for effective dispersion of the curable polymer and the nano filler. After the curable polymer and the nano filler are mixed for an effective time, for example 10 to 60 minutes by using the paste mixer, the nano filler in the curable polymer may be effectively dispersed by using 3-roll milling equipment for dozens of minutes. Accordingly, a curable nano composite with uniform nano filler dispersion may be formed.

When the curable nano composite 31 is provided on the mold 30, a pattern opposite to a surface pattern 30a of the mold 30, that is, a superhydrophobic pattern 31a, is formed on a surface of the curable nano composite 31. Next, a curing process may be performed.

Referring to FIG. 3C, the curable nano composite 31 is separated from the mold 30. Therefore, the curable nano composite 31 with the superhydrophobic pattern 31a may be manufactured. An image of a nano composite with superhydrophobic surfaces that is manufactured by using a curable nano composite material as described above is shown in FIG. 5A. In another embodiment, a separation layer may be formed for easily separating the mold 30 from the curable nano composite 31. However, a curable polymer with low surface energy, such as PDMS, may not need a separation layer.

Furthermore, a curable nano composite including a surface pattern according to an embodiment may be formed via an imprinting process. Specifically, after a curable nano composite is formed by mixing a curable polymer and a nano filler, the curable nano composite is applied onto a predetermined substrate. Next, an imprinting process is performed by sequentially applying heat or light and pressure to the curable nano composite by using a Ni press stamp. A superhydrophobic pattern formed on the Ni press stamp is then transferred to the curable nano composite. The substrate onto which the curable nano composite is applied may be placed on a hot plate. As a result, the superhydrophobic pattern may be transferred to the curable nano composite and both the curable nano composite and the superhydrophobic pattern may be cured at the same time.

### Experimental Example

To form a nano composite, a two-part, curable PDMS elastomer (Sylgard 184 SILICONE ELASTOMER BASE, DOW Corning) was used as a curable polymer, whereas multi-wall carbon nanotubes (“MWCNTs”) (Hanhwa Inotech) were used as a nano filler. The MWCNTs had diameters from about 10 nm to about 20 nm, lengths from about 100 μm to about 200 μm, and aspect ratios from about 3,000 to about 20,000 when delivered by the manufacturer. Nano composites were formed by respectively adjusting contents of nanotubes with respect to the overall mass of the nano composites to 1 wt %, 3 wt %, 5 wt %, 7.5 wt %, and 10 wt %. For effective dispersion of nanotubes in the nano composites, a paste mixer (DAE HWA TECH, PDM-1k) was used. Furthermore, 3-roll milling equipment (Ceramic 3 roll mill: INOUE MFG., INC.) was used to disperse nanotubes in the nano composites. Specifically, after the PDMS and the nanotubes were put into a predetermined container, the PDMS and the nanotubes were mixed for about 1 minute to about 5 minutes by using revolutions and rotations of the paste mixer. Next, the nanotubes were dispersed for about 5 minutes to about 30 minutes by using the 3-roll milling equipment. Accordingly, the nano composites were formed.

The nano composites were applied onto substrates, the substrates were placed on a hot plate, and the substrates were heated to about 120° C. Next, a Ni press stamp on which a superhydrophobic pattern (cylindrical structure, moth-eye, or dual hole, i.e., having holes with two or more diameters) is formed was located on the nano composites and an imprinting process was performed by applying a pressure of about 1000 Pascal (“Pa”) thereto for about 30 minutes. After the imprinting process, the superhydrophobic pattern formed on the Ni press stamp was transferred to the nano composites, and the nano composites were completely cured.

Hereinafter, formation of superhydrophobic surfaces of a nano composite according to an embodiment will be described with reference to the accompanied drawings.

FIG. 4A is a diagram showing a contact angle when a liquid drop is located on a surface of a solid between vapor and the solid. Here, it is assumed that the surface of the solid is not processed and is flat.

A contact angle θ between the liquid and the solid may be determined according to the Young's Equation shown in Equation 1 below.

γ_{LV} cos θ=γ_{SV}−γ_{SL} Equation 1

Here, γ_{LV} denotes liquid-vapor interfacial tension or surface tension, γ_{SV} denotes solid-vapor interfacial tension, and γ_{SL} denotes solid-liquid interfacial tension. Here, if the surface of the solid is not flat and has protrusions thereon, the contact angle may be determined according to two models below instead of according to the Young's Equation.

The first model is a Wenzel's model in which it is assumed that, when a liquid drop is dropped onto protrusions of a surface of a solid, the liquid drop completely wets from the protrusions to the surface. Here, a contact angle θ_{rw} of the liquid drop on the protrusions on the surface of the solid may be expressed as shown in Equation 2 below.

cos θ_{rw}=r cos θ, r=A_{SL}/A_{F} Equation 2

Here, r denotes a ratio between an area A_{SL} at which the liquid drop actually contacts the surface of the solid and an area A_{F} projected from above and may be defined as a roughness factor. When it is assumed that a shape of the protrusions formed on the surface of the solid is rectangular as shown in FIG. 4B, the roughness factor r may be expressed as shown in Equation 3 below.

r=(4ah²+p²)/p² Equation 3

According to the first model, if the contact angle θ of the liquid drop on the flat surface of the solid is smaller than 90° (cos θ>0), the contact angle θ_{rw} of the liquid drop on the uneven surface of the solid is smaller than θ. On the contrary, if the contact angle θ of the liquid drop on the flat surface of the solid is greater than 90° (cos θ<0), the contact angle θ_{rw} of the liquid drop on the uneven surface of the solid is greater than θ.

The second model is a Classie's model in which it is assumed that, when a liquid drop is dropped onto protrusions on an uneven surface of a solid, the liquid drop is located on the protrusion. Here, a contact angle θ, of the liquid drop on the uneven surface of the solid having formed thereon protrusions may be expressed as shown in Equation 4 below.

cos θ_{rc}=fₛ(1+cos θ)−1, fₛ=A_{SL}/A_{c} Equation 4

Here, fₛ (solid fraction) denotes a ratio between an area A_{SL} at which the liquid drop actually contacts the surface of the solid and an area A_{C} at which the liquid drop is projected onto the surface of the solid. If it is assumed that a protrusion formed on the surface of the solid has a rectangular pillar-like shape, fₛ may be expressed as shown in Equation 5 below.

fₛ=a²/p² Equation 5

When a liquid drop is dropped onto a surface of a solid, it may be determined which of the first and second models to be applied based on a tilting angle α of the protrusions formed on the surface of the solid and the contact angle θ. If a critical tilting angle α0 at which it is switched from the first model to the second model when a contact angle on a flat surface of a solid is θ, Equation 6 below is applied.

α0=180°−θ Equation 6

Referring to Equation 6, if a tilting angle of side surfaces of protrusions formed on a surface of a solid is smaller than the critical tilting angle (α<α0), the first model may be applied. On the contrary, if a tilting angle of side surfaces of protrusions formed on a surface of a solid is greater than the critical tilting angle (α>α0), the second model is applied.

For example, if a protrusion formed on a surface of a solid has a rectangular pillar-like shape as shown in FIG. 4B, a lateral width a, a pattern pitch p, and a pattern height h of a pattern are 6, 18, and 40, respectively. If a contact angle θ is 110°, a tilting angle of side surfaces of the protrusion is greater than the critical tilting angle (α>α0), and thus the second model may be applied. Here, fₛ is 0.11, and θ_{rc} is 158°. When a superhydrophobic pattern having the same dimensions is formed by performing an imprinting process, a value similar to a theoretical contact angle of the second model, that is, 158°, may be obtained.

By forming a superhydrophobic pattern for increasing a contact angle as described above, a structure with features including self-cleaning, anti-dew condensation, and low drag force may be embodied.

FIGS. 5A through 5D are diagrams showing surface images of a thermally-curable nano composite with superhydrophobic surfaces according to an embodiment.

Referring to FIGS. 5A through 5D, various types of superhydrophobic pattern 51 are formed on surfaces of a nano composite 50. The superhydrophobic pattern 51 may have a moth-eye arrangement (shown in FIG. 5A), and the individual protrusions may have a cylindrical shape (shown in FIG. 5D), or a polygonal pillar-like shape (not shown). By controlling such superhydrophobic surface patterns, a superhydrophobic surface with a contact angle of about 168.9° against liquid drops may be acquired.

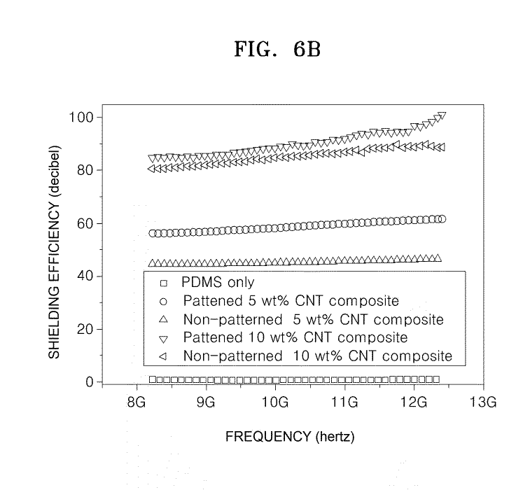

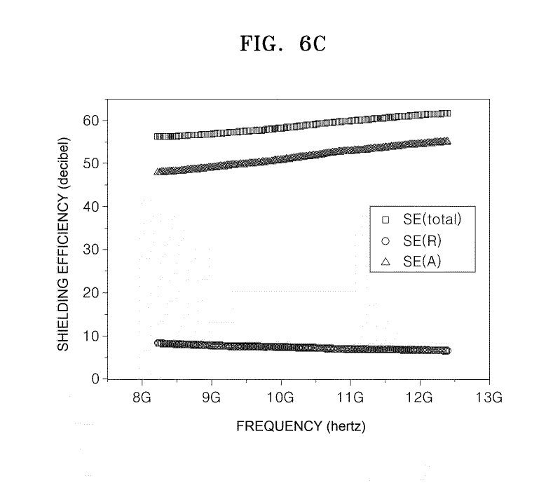

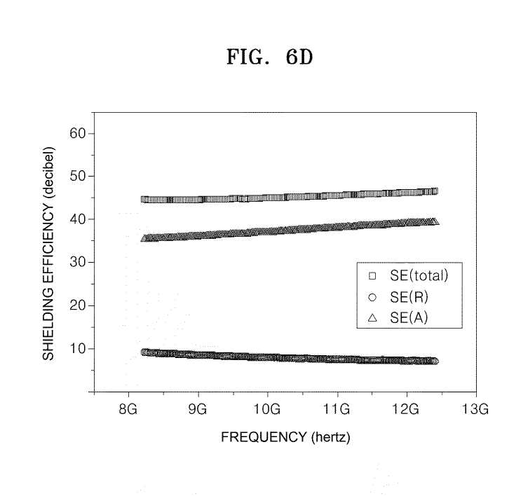

Hereinafter, an electromagnetic wave shielding feature of a nano composite with superhydrophobic surfaces according to an embodiment will be described with reference to FIGS. 6A through 6D.

FIG. 6A is a diagram showing a mechanism of shielding against electromagnetic waves. Referring to FIG. 6A, when an initial incident wave touches media 60, the initial incident wave is partially reflected (a reflected wave R), partially absorbed (A), and partially transmitted (a transmitted wave T). Here, the electromagnetic wave reflection occurs due to impedance differences at interfaces between media (air and media, polymer base and nanotubes). Furthermore, absorption of electromagnetic wave occurs as electromagnetic energy is absorbed as heat energy due to resistance loss and dielectric loss. The basic mechanism of shielding against electromagnetic waves includes absorption and reflection. An electromagnetic wave shielding efficiency may be analyzed by measuring the initial electromagnetic wave and the transmitted electromagnetic wave. To measure the electromagnetic wave shielding feature, a vector network analyzer (Agilent 5242A PNA-X) is used herein.

FIG. 6B is a graph showing an electromagnetic wave shielding feature of a nano composite with superhydrophobic surfaces according to an embodiment. Shielding efficiencies are measured with respect to three samples with superhydrophobic patterns and two samples without superhydrophobic patterns. The three samples with superhydrophobic patterns are formed of PDMS without carbon nanotubes (“CNTs”), PDMS containing CNTs (5 wt %), and PDMS containing CNTs (10 wt %), respectively. Furthermore, contents of CNT in the two samples without superhydrophobic patterns are 5 wt % and 10 wt %, respectively. In FIG. 6B, the horizontal axis indicates a range of electromagnetic wave shield measuring frequencies (hertz, “Hz”), whereas the vertical axis indicates shielding efficiency (“SE”, decibel, “dB”).

Referring to FIG. 6B, the sample formed of PDMS without CNTs is barely effective at shielding. Generally, if SE is 20 dB or higher, shielding efficiency is considered to be 99% or higher. For shielding against electromagnetic waves, a content of a nano filler with respect to the overall mass of a nano composite may be from about 1 wt % to about 50 wt %. Furthermore, a nano composite may have a shielding efficiency of 10 dB or higher with respect to electromagnetic waves with 10 GHz frequency. Shielding efficiencies of the nano composites with 5 wt % and 10 wt % of CNTs are significantly higher than 20 dB. Furthermore, when the samples with the same content of CNTs are compared, the samples with superhydrophobic surface patterns have relatively high shielding efficiencies as compared to the samples without superhydrophobic surface patterns. Therefore, a nano composite with superhydrophobic surfaces may be stably used as a shielding material.

A nano composite with superhydrophobic surfaces has higher shielding efficiency, because the nano composite has a larger surface area than a nano composite without superhydrophobic surfaces. For example, if a surface area of a nano composite with flat surfaces is 100, a superhydrophobic pattern (protruding cylinder, moth-eye, dual holes) may have a surface area from about 300 to about 800. If conductivity is high and a surface area is large, with respect to electromagnetic wave shielding, electromagnetic waves tend to be more absorbed.

In detail, the total shielding efficiency SE (total) is divided into reflection and absorption efficiencies. The total shielding efficiency SE (total) is as shown in Equation 7 below.

SE(total)=SE(R)+SE(A) Equation 7

Here, SE (R) indicates a shielding efficiency via reflection, whereas SE (A) indicates a shielding efficiency via absorption. Furthermore, SE (R) and SE (A) are defined as shown in Equation 8 below.

SE(R)=−10 log(1−R),

SE(A)=−10 log((T)/(1−R)) Equation 8

Here, T=|S21|², R=|S11|², and A=1−|S11|²-|S21|². S11 and S21 are S parameters of media measured by using the vector network analyzer, where S11 indicates an initial electromagnetic wave, and S21 indicates a transmitted electromagnetic wave.

According to Equations 7 and 8 above, shielding efficiencies via reflection and shielding efficiencies via absorption of a nano composite with superhydrophobic surfaces (5 wt %) and a normal nano composite are shown in FIGS. 6C and 6D, respectively. The total shielding efficiency SE (total) is divided into the shielding efficiency via reflection SE (R) and the shielding efficiency via absorption SE (A). Comparing the result regarding the nano composite with superhydrophobic surfaces shown in FIG. 6C to the result regarding the normal nano composite shown in FIG. 6D, the shielding efficiency via reflection SE (R) of the nano composite with superhydrophobic surfaces is similar to that of the normal nano composite, whereas the shielding efficiency via absorption SE (A) of the nano composite with superhydrophobic surfaces is significantly different from that of the normal nano composite. Nano composites with 5 wt % and 10 wt % CNTs have electric conductivities of 80 Siemens per meter (“S/m”) and 240 S/m, respectively. In this case, the nano composites may have high resistance heat generating efficiencies based on Joule heating (P=IV=I2R), and thus the nano composites may be used as a shielding member, a heating member or a deicing member.

According to embodiments, a nano composite with improved resistances against possible pollution and damages due to exposure to outside environments may be provided by forming superhydrophobic surfaces directly on the nano composite. Furthermore, the nano composite with superhydrophobic surfaces has a self-cleaning feature and an excellent electromagnetic shielding efficiency.

Furthermore, according to a method of manufacturing a nano composite with superhydrophobic surfaces according to an embodiment, a nano composite with large superhydrophobic surfaces may be provided by forming a superhydrophobic surface directly on a nano composite via a molding process or a press stamping process, and thus efficiency and productivity of manufacturing processes may be significantly improved.

It should be understood that the exemplary embodiments described therein shall be considered in a descriptive sense only and not for purposes of limitation. Descriptions of features, advantages, or aspects within each embodiment shall be considered as available for other similar features, advantages, or aspects in other embodiments.

What is claimed is:

1. A nano composite with superhydrophobic surfaces, the nano composite comprising:
a bulk portion; and
a surface portion having a superhydrophobic pattern comprising a plurality of protrusions,
wherein the bulk portion and the surface portion comprise the same material.

2. The nano composite of claim 1, wherein a width of the protrusions, a height of the protrusions, and an interval between the protrusions are from about 10 nanometer to about 500 micrometers.

3. The nano composite of claim 1, wherein the surface portion has a contact angle equal to or greater than 130° and less than 180°.

4. The nano composite of claim 3, wherein the protrusions are of a cylindrical shape, polygonal pillar-like shape, or a conical shape.

5. The nano composite of claim 3, wherein the plurality of protrusions form a moth-eye pattern.

6. The nano composite of claim 1, wherein the materials of the nano composite comprises a polymer base and a nano filler.

7. The nano composite of claim 6, wherein the polymer base comprises a thermoplastic polymer.

8. The nano composite of claim 6, wherein the polymer base comprises a curable polymer.

9. The nano composite of claim 6, wherein the nano filler comprises carbon black, carbon nanotubes, carbon fibers, nano wires, graphene, or nano particles.

10. The nano composite of claim 6, wherein the nano filler comprises carbon nanotubes.

11. The nano composite of claim 6, wherein a content of the nano filler with respect to the overall weight of the nano composite is from about 0.01 weight percent to about 50 weight percent.

12. The nano composite of claim 11, wherein the nano composite has a shielding efficiency of 10 decibel or higher with respect to electromagnetic waves with 10 gigahertz frequency.

13. The nano composite of claim 12, wherein the nano composite exhibits a contact angle equal to or greater than 130°.

14. The nano composite of claim 12, wherein a surface area of a region in which the superhydrophobic pattern is formed is 2 or more times larger than that of a flat surface of the equivalent region.

15. A superhydrophobic electromagnetic shielding member comprising the nano composite with superhydrophobic surfaces of claim 1.

16. A superhydrophobic heating member comprising the nano composite with superhydrophobic surfaces of claim 1.

17. A superhydrophobic deicing member comprising the nano composite with superhydrophobic surfaces of claim 1.

18. A method of manufacturing a nano composite with superhydrophobic surfaces, the method comprising:
providing a nano composite material comprising a polymer base and a nano filler; and
contacting a surface of a mold comprising a superhydrophobic pattern to a surface of the nano composite material.

19. The method of claim 18, wherein the polymer base comprises a curable polymer, and
the contacting of the surface of the mold to the surface of the nano composite material further comprises curing the nano composite material by providing heat or light thereto.

20. The method of claim 18, wherein the polymer base comprises a thermoplastic polymer, and
the contacting of the surface of the mold to the surface of the nano composite material comprises further comprises applying heat to raise the temperature of the thermoplastic polymer to near the melting point of the thermoplastic polymer and applying pressure to the nano composite material.
